(19) United States
(12) Patent Application Publication
(10) Pub. No.: US 2008/0215625 A1
(43) Pub. Date: Sep. 4, 2008

(54) Marking Sample Carriers

(76) Inventors: Jeffrey Douglas Veitch, Hertfordshire (GB); William Kerckhoff Young, Hertfordshire (GB)

Correspondence Address: GLAXOSMITHKLINE;CORPORATE INTELLECTUAL PROPERTY, MAI B482, FIVE MOORE DR., PO BOX 13398, RESEARCH TRIANGLE PARK, NC, 27709-3398, US

(21) Appl. No.: 11/995,247

(22) PCT Filed: Jul. 10, 2006
(86) PCT No.: PCT/GB2006/002559

§ 371 Date: Jan. 10, 2008

(30) Foreign Application Priority Data
Jul. 12, 2005 (GB) 0514293.0

(51) Int. Cl. G06F 17/30; H04Q 5/22

(52) U.S. Cl. 707/104.1; 340/10.1; 340/10.51; 707/E17.044

(57) ABSTRACT

A method of marking a biological sample carrier by transferring information from a first information medium forming part of the sample carrier to a second information medium. The first information medium is optically readable and the second information medium is electronically readable. The method comprises the steps of determining first information from the first information medium, associating the first information with the second information medium and storing the sample carrier with the second information medium attached to the sample carrier.

### FIELD OF THE INVENTION

The present invention relates to a method of marking sample carriers, in particular, biological sample carriers such as microscope slides. The invention also relates to an apparatus, and computer software, arranged to conduct the method of the invention, and to a sample carrier that can be used in the method.

### BACKGROUND OF THE INVENTION

Biological sample carriers have been known for a long time and are widely used in the health industry. Microscope slides for instance are typically used to mount a biological sample, for instance a section of a tissue sample, for microscope examination or for different types of manipulation such as chemical processing. Microscope slides are also provided with an information medium which is a marking surface usually situated next to the tissue sample on the slide. The information medium contains information which is unique to the tissue sample that is applied to the slide. The information can identify for instance the type of animal from which the tissue sample has been taken, the study from which the tissue sample comes and/or the slice number from the tissue sample.

The information medium may contain human readable information, for example alphanumeric data. In that case, the human readable information may be handwritten, etched into the slide, ink printed directly on the slide or printed onto a paper label which is stuck onto the slide. The information medium can also be machine readable, the corresponding information being stored for example in a barcode and optically read using a barcode reader. Alternatively, the information medium can be both human and machine readable.

Both methods of storing information have a number of problems. First, there is a limitation on the amount of information that can be stored on the slides. Also, updating and amending of the information is difficult, if not impossible. Handwritten data on a label is, after some time, not any more legible. Finally, in order to read the information stored in a slide having a bar code, it is necessary to have a clear line-of-sight between the barcode of the slide and a bar code reader.

Handling a batch of microscope slides having different methods of storing information is somewhat complicated and slow as it requires different means to read the stored information on each different slide comprised in the batch.

It would thus be desirable to provide a simple and fast solution to mark a biological sample carrier with an information medium in order to simplify handling of the slides.

### SUMMARY OF THE INVENTION

In accordance with a first aspect of the present invention, there is provided a method of marking a biological sample carrier by transferring information from a first information medium forming part of the sample carrier to a second information medium, said first information medium being optically readable and said second information medium being electronically readable, said method comprising:

(a) determining first information from said first information medium;

(b) associating said first information with said second information medium;

(c) storing said sample carrier with said second information medium attached to said sample carrier.

The invention proposes a method for marking a sample carrier comprising a first information medium by use of a second information medium, which is attached to it before a sample carrier is stored. The information of the first information medium, which is optically readable, is transferred to the second information medium, which is electronically readable.

By marking each sample carrier of a batch with a uniform second information medium, the handling of the batch of sample carriers is simplified as it requires one electronic means to read the second information medium of each sample carrier of the batch.

The solution of the invention has the advantage that the amount of information that can be stored on a sample carrier is greatly increased. Also, updating and amending of the information is made easier.

In accordance with a second aspect of the present invention, there is provided an apparatus for marking a biological sample carrier by transferring information from a first information medium forming part of the sample carrier with a second information medium, said first information medium being optically readable and said second information medium being electronically readable and affixable or affixed to the sample carrier, said apparatus comprising:

(a) a reader for reading first information from said first information medium;

(b) a writer for writing said first information in said second information medium.

By providing an apparatus and associated computer software for transferring the information of a first information medium of a sample carrier to a second information medium affixable or affixed to the sample carrier, the marking of a sample carrier requires minimal human intervention.

By also providing a database associated with the apparatus and by storing the information of the first information medium of a sample carrier in the database, the solution of the invention simplifies the problem of keeping track of the whereabouts of slides between different sites, as it avoids paper records of the whereabouts. The solution of the invention also simplifies the archiving and counting of slides which is usually conducted manually, making it less time-consuming and less prone to errors.

In accordance with a third aspect of the present invention, there is provided a biological sample carrier comprising a first information medium and a second information medium, the first information medium being of a different kind than the second information medium, and having a part for receiving a sample.

Further aspects of the invention are set out in the appended claims.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1 illustrates an example of a method of marking microscope slides.

FIG. 2 shows an embodiment of the apparatus according to the invention.

FIGS. 3, 4a, 5, 6a, 7a, 8 show several interfaces of the computer software which is associated with the system of the invention.

FIGS. 4b and 6d show a table which illustrates in a basic manner the structure of the database associated with the apparatus of the invention.

FIG. 6b shows a radio frequency identification tag.

FIG. 6c shows a roll of radio frequency identification tag labels.

FIG. 7b illustrates in a basic manner the data stored in the archive database associated with the apparatus of the invention.

FIGS. 9a to 13 and 14 show several interfaces of the computer software which is associated with the system of the present invention.

FIG. 13a shows an example of a movement report which is obtained from the interface of FIG. 13.

### DETAILED DESCRIPTION OF THE INVENTION

The invention will be described in relation to microscope slides. This is not intended to be limiting in any way since the invention can be applied to other types of biological sample carriers.

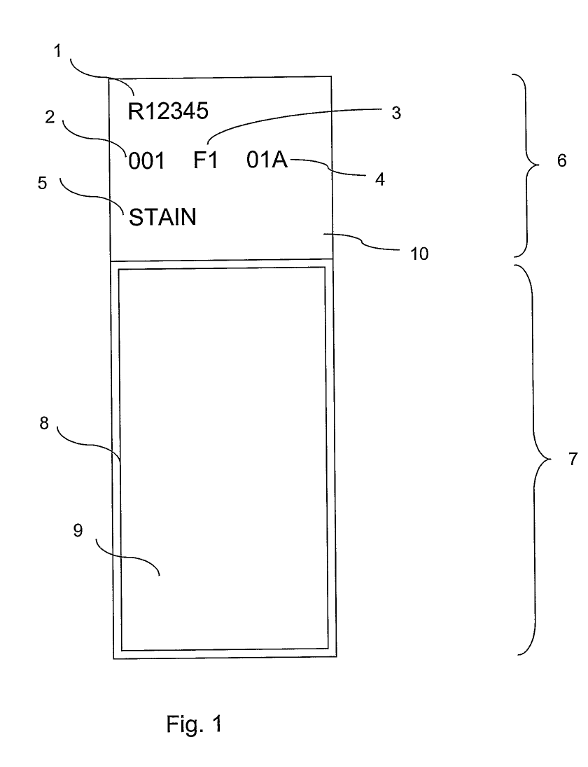

FIG. 1 illustrates an example of a method of marking microscope slides. The slide is a rectangular transparent glass or plastic plate having on one side a surface with a first part 6 and a second part 7. On the second part 7, the slide receives a tissue sample 9, the sample being covered by a protective cover slip 8 which is made of glass or plastic and confines the tissue sample 9 to a thin layer. The first part 6 comprises a marking portion 10, which will be referred as a first information medium, and which forms part of the slide. This is intended to mean that the first information medium is either part of the slide, e.g. a rough surface of the slide which can be etched for instance, or is physically connected to the slide in a permanent or removable manner, e.g. an adhesive label affixed to the slide. The first information medium may include information relating to the tissue sample 9 on the slide. In the example shown, the information is encoded into five alphanumeric strings which are for example etched into the glass material of which the slide is made. The encoding of the information relating to the tissue sample into five alphanumeric strings is realised according to the following process.

In a known method of conducting a medical experiment or study, several animals are selected, the animals being separated in groups which receive a different dose of a treatment for instance. For each animal, several tissue samples are taken and each sample is mounted on a microscope slide. The first information medium 10 of a slide comprises a study number with reference number 1, which is presented on the first line of the first information medium. The study number 1 consists of a prefix letter denoting the species of an animal, such as “R” for rat or “D” for dog. The prefix letter is followed by a five figure number for instance. Each study being generally conducted on at least two animals, each animal is uniquely identified by an animal number with reference number 2 and presented on the left side of the second line. The animal number 2 is composed of three digits, starting from “001” and incremented accordingly. As mentioned previously, each study has one or more dose groups with reference number 3 into which the animals are grouped. Each dose group is defined by a prefix “M” or “F”, designating the sex of the animal, followed by a dose identification number. For any given study, the dose group is identical for all the slides relating to a given animal. Each slide includes a slide number indicated by reference numeral 4, which is for example composed of two digits with an optional suffix letter and is indicated on the second line of the first information medium. For a given study, the set of slide numbers for the slides with samples from the one animal are equal for all animals, e.g. all animals on a study require for example slide numbers “01”, “02”, “03A”, “03B”, “07”, “10”, “12”. It is often helpful to increase the contrast of the specimen sample structure affixed to the slide so that it can be seen more clearly, and thus demonstrates a particular structure or substance. Chemicals that dye parts of a sample for this purpose are called stains. When a slide is stained, the type of stain is recorded on the third line of the first information medium 10 of the slide as an alphanumeric string with reference number 5.

The method of the present invention for marking one or more microscope slides will now be described. The one or more slides may correspond to a single study, the slides being stored on trays which are stacked in one or more boxes pertaining to the same study, and referred to as study boxes. In this embodiment of the method, the first information medium of each slide has the configuration shown in FIG. 1. However, this configuration is not intended to be limiting in any way, since alternative configurations of the information medium could equally be used to similar effect. The invention also applies to other processes for coding the information relating to the tissue sample present on a slide.

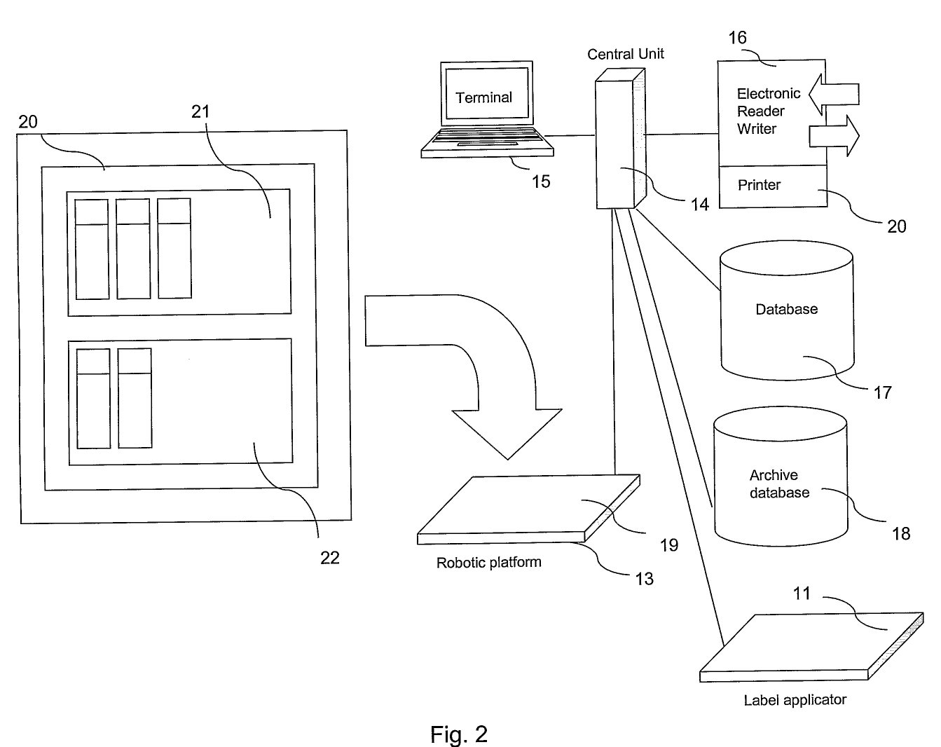

FIG. 2 shows an embodiment of the apparatus according to the invention. The apparatus of the invention comprises a robotic platform 13 which includes a tray holder 19, a video capture device and an illumination unit (not shown). The apparatus also comprises a central unit 14 which contains a data processor for running optical character recognition (OCR) software and a memory. The apparatus comprises a user terminal 15 linked to the central unit 14 in order for a user to operate the system using associated computer software. The apparatus also comprises a combined electronic reader/writer 16, preferably a radio frequency identification (RFID) reader/writer, even more preferably a RFID reader/writer which is incorporated in a printer 20. The apparatus comprises a database 17 and in a preferred embodiment a further remote archive database 18. The apparatus may also comprise a label applicator 11. A tray 20 having two rows 21 and 22 in which are arranged a number of slides is presented to the robotic platform 13. Preferably an array of a maximum of twenty four slides is accommodated in two rows of twelve slides in the tray 20, each of the slides having a specimen sample applied onto it. Optionally, the tray has means for holding slides securely and fixedly.

The embodiment of the method according to the invention uses the robotic platform and OCR software to scan the first information medium of each microscope slide accommodated on the tray and to determine first information from the first information medium of each microscope slide. As will be explained below, the first information of a slide is written in a second information medium which is already attached to the microscope slide or attached after the first information is written in it. The first information medium is optically readable. The second information medium is electronically readable, by contact or not, using galvanic means or radio frequency (RF) means for instance. The embodiment of the method will be described using screen shots of an application as may be presented to a user or to an administrator on the user terminal 15 in order to operate the system. Access to the application by a user could be made secure, requiring a username and password. Authentication of a user could also be enabled by a login procedure.

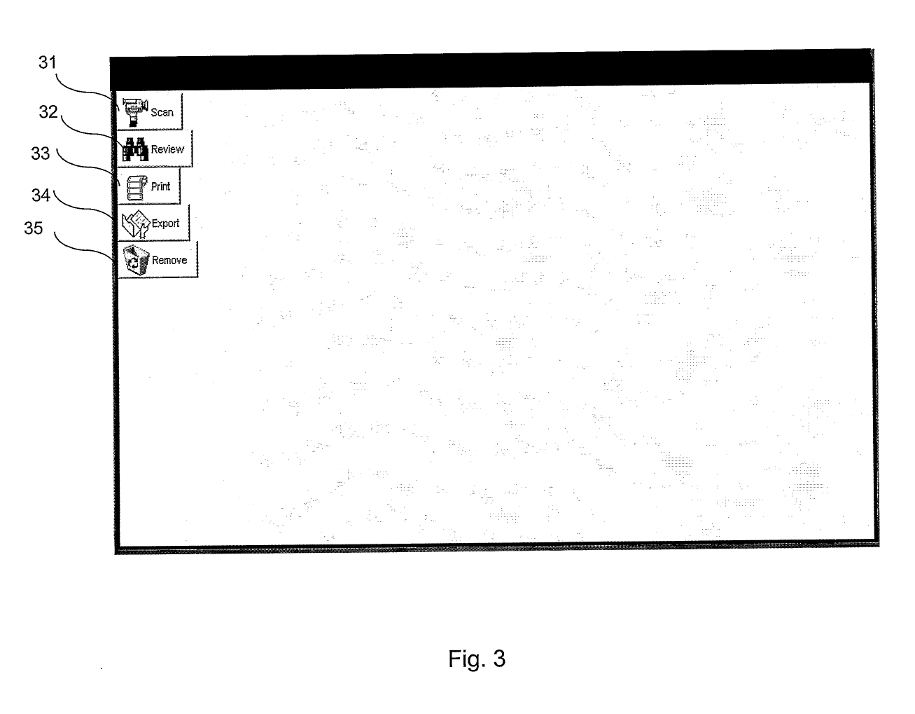

As shown in FIG. 3, a user has accessed the application and is first presented with an interface displaying a vertical toolbar which comprises five icons, namely “scan” 31, “review” 32, “print” 33, “export” 34 and “remove” 35. At that stage, the five icons are enabled, i.e. any of them could be pressed by the user, and an introductory text could additionally be displayed on the interface. Assuming that a tray of microscope slides similar to the one shown on FIG. 2 is loaded on the robotic platform 13, the user initiates scanning of the tray by clicking on the “scan” icon 31 of the toolbar.

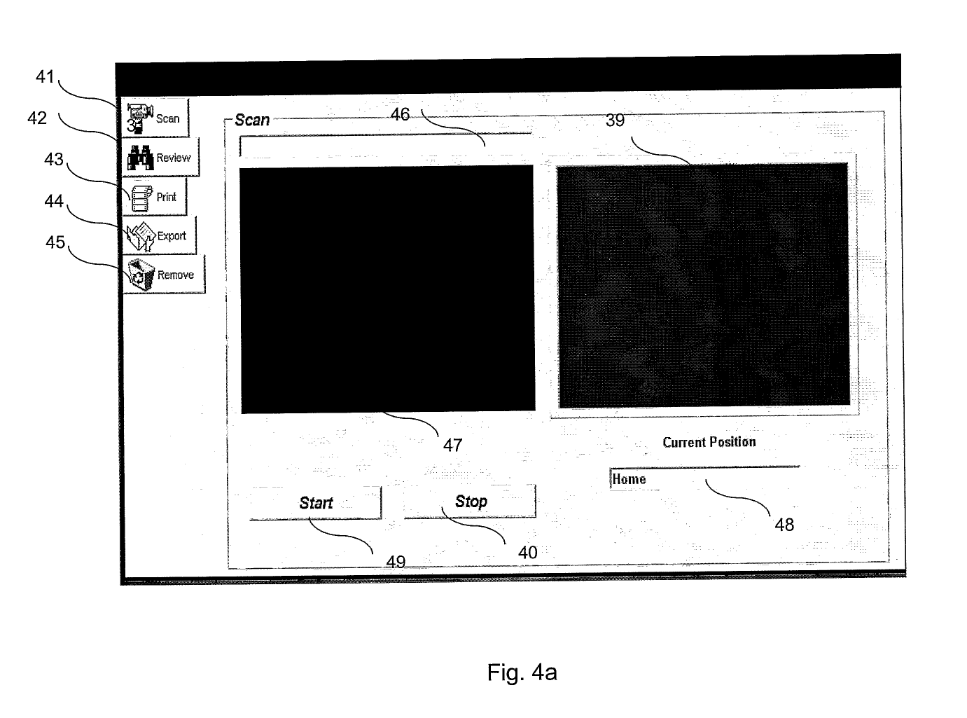

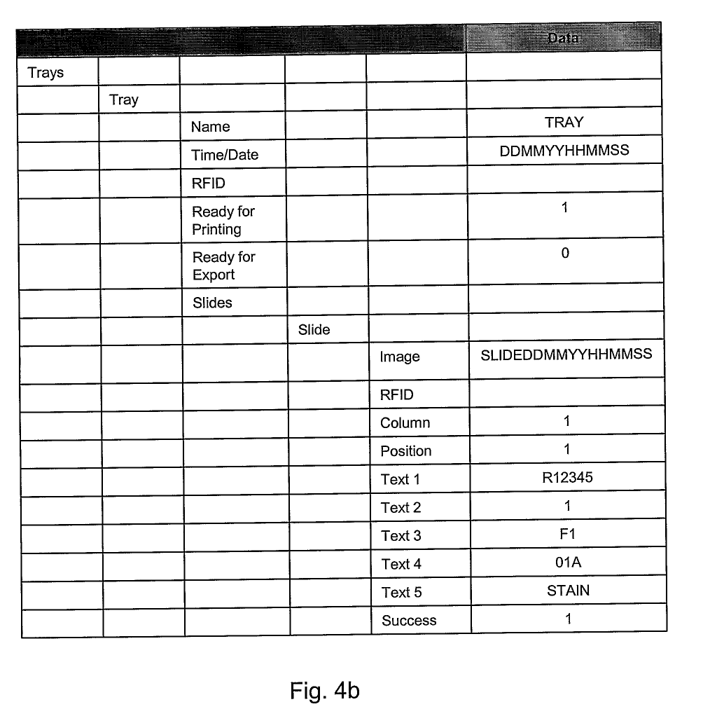

Before any scanning process is enabled, the user is presented with the interface shown in FIG. 4a. The interface has an identical vertical toolbar with icons 41, 42, 43, 44 and 45 similar to the ones shown in FIG. 3. It also comprises a tray edit box 46, an image box 47, an image capture control box 39, a “current position” box 48, a “start” button 49 to start scanning and a “stop” button 40 to stop scanning at any time during the process. When the “start” button 49 is pressed by the user, the vertical toolbar is consequently disabled. Whenever the “stop” button 40 is pressed by the user, the vertical toolbar is again enabled. After pressing the “start” button, the tray edit box 46 is cleared and a tray name is automatically created. The tray name could be in a standard format including the prefix “Tray” plus the time and date of creation such as “TrayDDMMYYHHMMSS”. Then, the robotic platform starts a scan cycle, which consists in scanning the first information medium of the slides which are situated in both columns of the tray and capturing an image of the first information medium of each slide at set intervals. The scan cycle preferably starts on the top column of the tray, going from left to right.

The image box 47 displays the image of the video capture device in real-time. An image of the first information medium of a first slide is captured by the robotic platform. It is stored in a named directory in the memory of the central unit, in bitmap format for example, where the captured images of the following slides of that tray will also be stored. The format of the slide name could be a standard format including the prefix “Slide” plus the time and date of creation such as “SlideDDMMYYHHMMSS”. The most recently captured image is displayed in the image capture control box 39. The OCR software uses an algorithm to search for any alphanumeric information on the captured image of the first information medium of the slide and to draw an array of five boxes on the captured image. The five boxes surround the five alphanumeric strings which encode the first information, as shown on FIG. 1. Using the OCR software, the first information is determined from the captured image. The position data of the slide on the tray is indicated in the “current position” box 48, preferably in numeric form, a first number indicating the tray column and a second number indicating the position of the slide in that column. For that particular tray, the first information and the position data of the first slide are stored by the application under the tray name mentioned above. The process is iterated for the following slide. When scanning of the slides in the tray is completed, the database 17 associated with the robotic platform is updated with the tray and corresponding data of each slide. Additionally, the current position box 48 is set to home and the vertical toolbar of the interface is enabled. At this point of the process, a new tray could be loaded onto the robotic platform and a new scan cycle launched by the user.

FIG. 4b shows a table which illustrates in a basic manner the structure of the database associated with the apparatus of the invention. The table only shows the stored data associated with one slide after a scan cycle of a tray has been completed. The database 17 is preferably an Extensible Mark-up Language (XML) database. The tray name, the slide name, the first information, the column and position of the slide are indicated on the right hand side of the table. The Boolean value of the “ready for printing” tray data is “1” and Boolean value of the “ready for export” tray data is “0”. Data referring to RFID tags is blank at that stage and will be explained later. The “success” data is “1” if scanning of a slide was successful and is “0” if unsuccessful. In the table shown in FIG. 4b, the scanning of the first slide was successful and the tray is “ready for printing” but not “ready for export”.

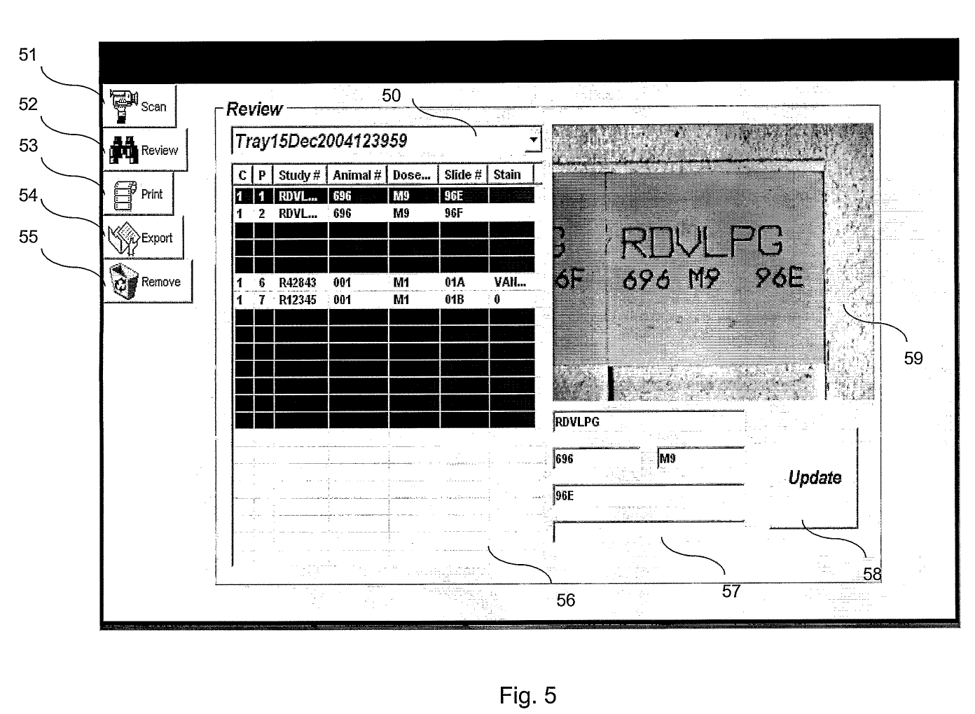

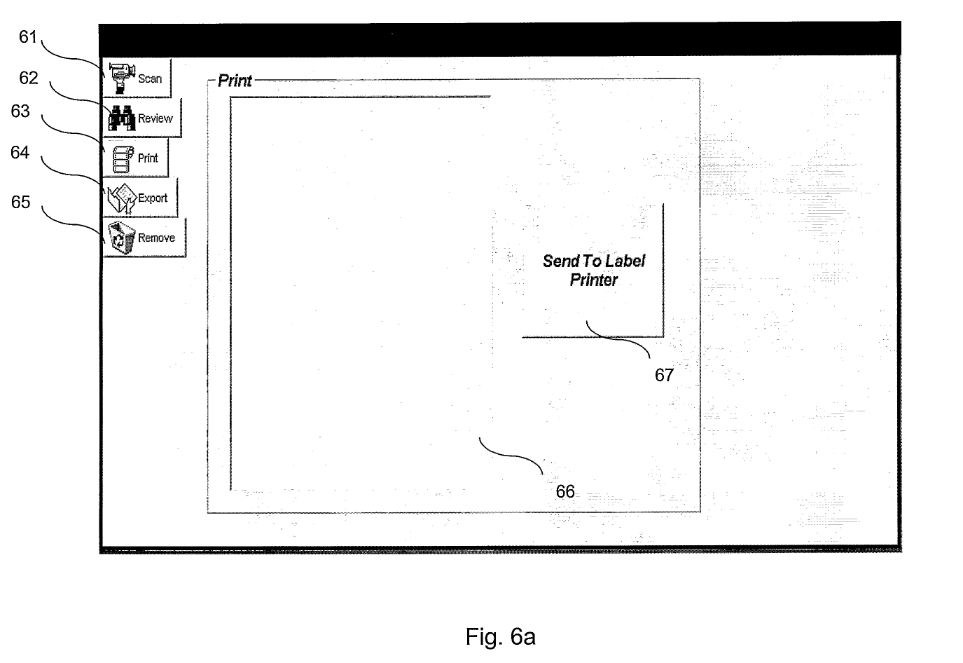

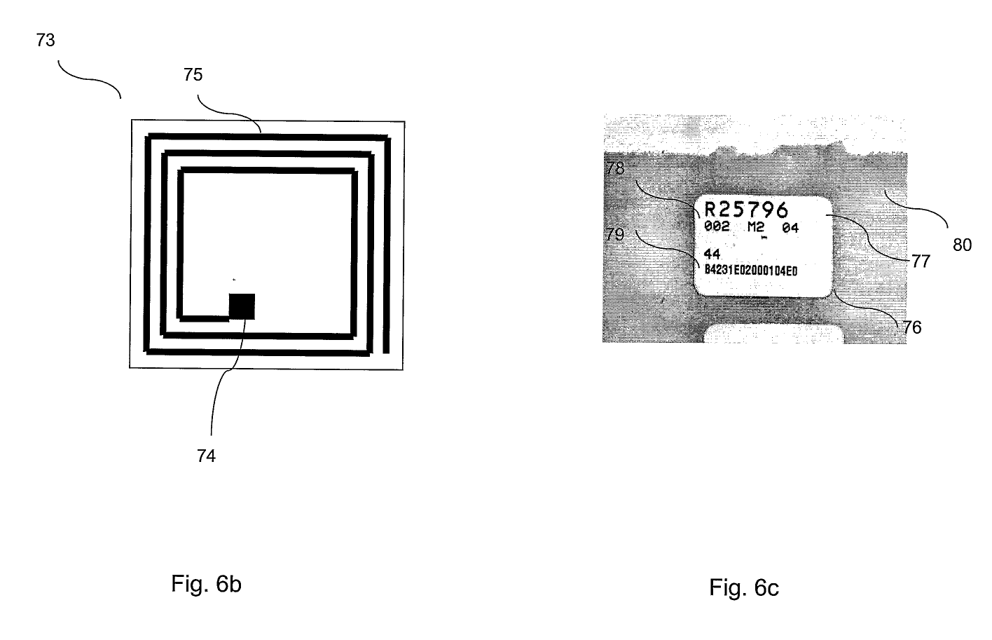

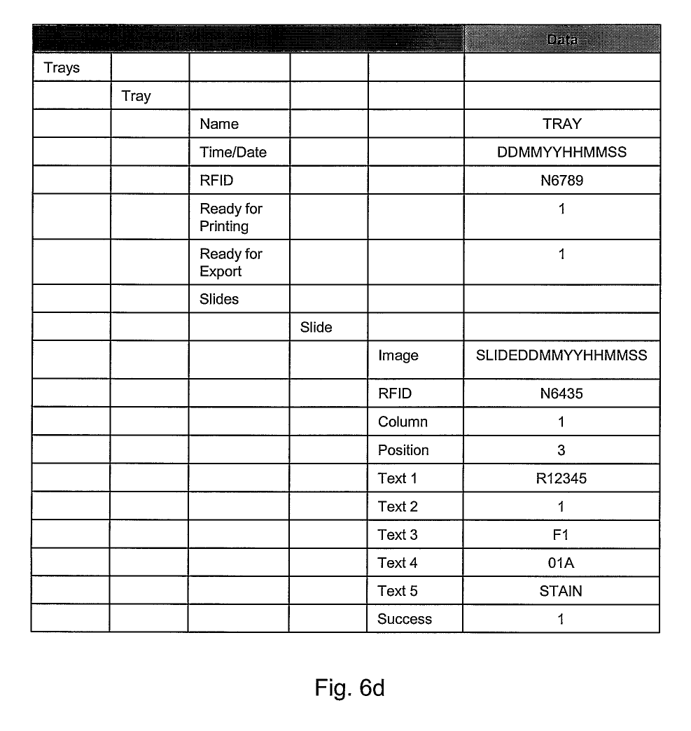

Referring back to FIG. 4a, by clicking on the “review” button 42, the user is presented with the interface shown on FIG. 5. The interface includes a tray box 50 which can be used to select a tray name among the ones already scanned and whose corresponding data is stored in the database 17. For a chosen tray name, the grid 56 is populated with the data of the corresponding slides of that tray. The grid 56 includes for each slide the position data and the first information which is composed of the five alphanumeric strings mentioned above, namely a study number, an animal number, a dose group, a slide number and eventually a stain type. Using the grid 56, the user can check if all slides actually belong to the same study. Also, the user can check if any data is missing for one or more slides which would indicate that the scanning was unsuccessful. When the user selects an entry in the list of slides of the grid 56, the line is highlighted and the user can view the captured image of the first information medium of the corresponding slide in the picture box 59. The five boxes 57 are also populated with the corresponding first information, i.e. the five alphanumeric strings of the selected slide. The boxes 57 are configured to allow the user to input or amend an entry. In the case where the scanning of a slide was unsuccessful, the new data entered by the user is only updated in the database 17 if the user presses the “update” button 58. The database 17 is only updated after the pattern of each alphanumeric entry made by the user has been checked and corresponds to the pattern of the five alphanumeric strings described in relation to FIG. 1. Consequently, the “success” data of that slide is modified from “0” to “1” in the database 17. At this point of the process, for each slide of a tray, the user can initiate the writing of the first information in a second information medium. The second information medium is electronically readable. It is preferably an RFID tag as shown schematically in FIG. 6b. The shape of the RFID tag is not limited to the shape of FIG. 6b. As is well known, an RFID tag 73 includes a microchip 74 and an antenna 75. The RFID tag is for example a passive tag operating at 13.56 MHz. Its microchip may store identification data, i.e. a unique identification number. Other data may be read and/or written in the microchip of the RFID tag using a RFID tag reader and/or writer.

In one embodiment, the writing of the first information in the second information medium, i.e. the RFID tag, is conducted using the combined RFID reader/writer 16 of the apparatus represented in FIG. 2.

In a preferred embodiment which will now be described, the RFID tag is mounted on a label, referred to as a RFID tag label. The combined RFID reader/writer is incorporated in a printer 20, referred to as RFID reader/writer printer, in which a RFID tag label is inserted. The writing of first information in the RFID tag and the printing of the label comprising the RFID tag is conducted using the RFID reader/writer printer. The user enables the writing and printing operations by clicking on the “print” button 53 of the vertical toolbar.

FIG. 6a illustrates the interface which is thus presented to the user. A box 66 is populated with all the tray names stored in the database 17. The data associated with each tray is supposedly error free. After selecting a single tray name, the user activates the “send to label printer” button 67 in order to extract the data associated with the tray and the corresponding slides from the local database. This data is subsequently sent to the RFID reader/writer printer 16.

Before the “send to label printer” button 67 is activated, a roll of RFID tag labels has been inserted in the RFID reader/writer printer 16. A part of the roll is shown on FIG. 6c. The roll comprises several RFID tag labels 76 which are affixed on a support layer 80. Each RFID tag label has possibly a printable layer 77 affixed on top of an RFID tag. Before printing, the printable layer 77 is preferably blank. The RFID tag label may be of square shape, round shape or any other shape. The RFID reader/writer printer 16, 20 reads the identification data of the second information medium, i.e. the first RFID tag on the roll. The unique identification data is transmitted to the database 17 where it is stored in correspondence with the first information of the first slide. Having received the data associated with the tray and the corresponding slides from the local database, the RFID reader/writer printer configures the RFID tag and then writes the first information from a first slide, i.e. the five alphanumeric strings corresponding to a study number, an animal number, a dose group, a slide number and eventually a stain type, in the RFID tag, also referred as second information medium. The RFID reader/writer printer then reads the RFID tag to check that the first information has been written correctly.

In an alternative embodiment, the RFID tag does not initially store any identification data. In that case, the RFID reader/writer printer writes the first information but also identification data in the RFID tag. The first information and identification data are subsequently transmitted to the database 17.

The RFID reader/writer printer may print part or all of the first information 78 of the slide on the layer 77 and may additionally print the RFID tag identification data 79 on the layer 77. The process is reiterated for each microscope slide of the tray, a different RFID tag label being printed for each microscope slide. The printed RFID tag labels are then affixed manually on the corresponding slides using an adhesive or any other means. Alternatively, the tag labels are affixed automatically using the label applicator 11 shown in FIG. 1. A printed RFID tag label is either attached on top of the first information medium of a slide, at the back of the slide or on a side of the tissue sample portion. One information locator means which provides an indication on where to attach the RFID tag label on the slide may be a slot or a marker. The marker may be a protrusion, delimitating lines or four corners which resemble the shape of the RFID tag label.

In another embodiment, the microscope slide may already have an RFID tag label affixed to it before first information is written into it.

As mentioned above, the method according to the invention may duplicate the first information and the identification data of the second information medium by storing it in the RFID tag and by printing it on the layer 77. This allows a person sticking a RFID tag label on a slide to check that the correct RFID tag label is applied to the slide. Once the RFID tag labels have been applied to the correct slides, it also allows a person to retrieve a slide by simply reading the data on the layer 77 in case the person does not have a tag reading device. Referring to FIG. 6a, the vertical tool bar of the interface is disabled during the writing and printing operations. Optionally a box describing the progress of the operations may pop up on the screen. Once the writing and printing of all slides in a tray is completed, the tool bar is enabled again. In case no tray selection has been made and the user presses the “send to label printer” button 67, a message box prompting the user to select a tray in box 66 is displayed.

An alternative to writing the first information in the second information medium by use of a RFID reader/writer printer is to associate the first information with the second information medium in a database, the second information medium only storing identification data.

The method according to the invention uses the same or a different RFID reader/writer printer to print a third information medium which is attached to a tray. The third information medium is electronically readable, preferably an RFID tag, and is intended to store the first information of the one or more slides accommodated on the tray. The RFID reader/writer printer writes first information of the one or more slides from the local database in the RFID tag. The printer also reads the identification data from the third information medium, i.e. the unique identification number of the RFID tag. The identification data of the third information medium is transmitted to the database 17 where it is stored in correspondence with the first information and the identification data of the second information medium.

In an alternative embodiment, the RFID tag does not initially store identification data. In that case, the RFID reader/writer printer writes first information of the one or more slides but also identification data in the RFID tag before identification data is transmitted to the database 17.

The printer may print the tray name and the RFID tag identification data on the layer 77 of the RFID tag label. The RFID tag label is subsequently attached to the tray automatically, using the above mentioned label applicator, or manually. One information locator means which provides an indication on where to attach the RFID tag label on the tray may be a slot or a marker. The marker may be a protrusion, delimitating lines or four corners which resemble the shape of the RFID tag label. In another embodiment, the tray may already have a RFID tag affixed to it before first information of the one or more slides on the tray is written.

Similarly to FIG. 4b, FIG. 6d shows a table which illustrates in a basic manner the structure of the database associated with the apparatus of the invention, once writing and printing of the RFID tag labels for a tray and the corresponding slides has been conducted. The Boolean value of the “ready for export” tray data is now “1” meaning that the tray is “ready for export”. The “RFID” identification data of the tray and associated slides has been updated in the local database.

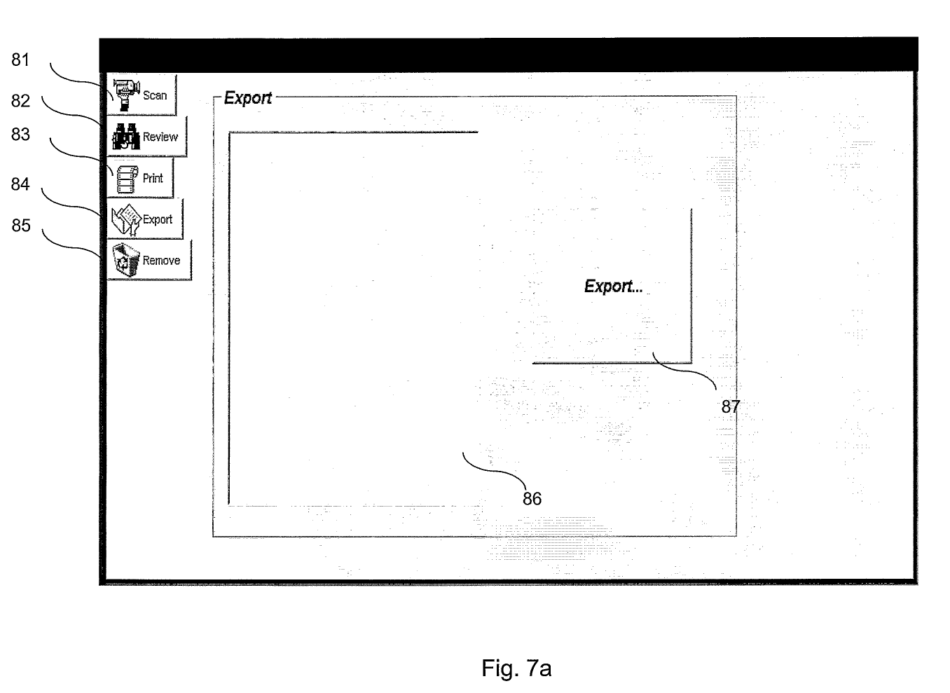

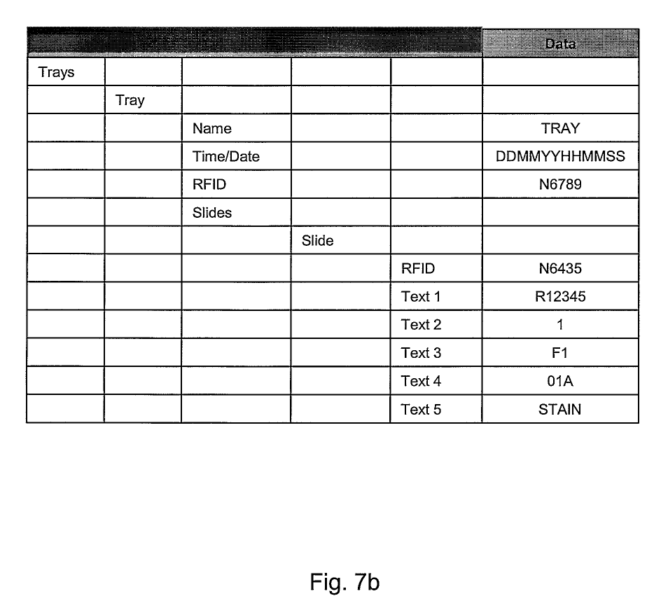

Referring back to FIG. 6a, when the user wishes to archive the data associated with one or more trays from the database 17 to the archive database 18, the user selects the export icon 64. FIG. 7a shows the interface presented to the user. It includes a list box 86 which comprises a list of trays which have supposedly been scanned and which are ready for export. Only the trays with slides that have corresponding RFID tag identification data are listed. The information displayed in the list box 86 is retrieved from the database 17, such as shown on FIG. 6c. The list box is configured for single or multiple selections of trays. If the “export” button 87 is pressed, the data associated with the one or more trays selected is exported, as an XML file for example, from the database 17 to the archive database 18. In case no tray selection is made and the user presses the “export” button 87, a message box prompting the user to select one or more trays in the list box 86 is displayed. An updated list of exported trays could be made available to a user.

FIG. 7b illustrates in a basic manner the data stored in the archive database associated with the apparatus of the invention. This data is limited to a tray and a slide for simplification purposes. The data has been exported from the database 17 to the archive database 18 associated to the apparatus of the invention. The exported data are the tray name, the identification data of the RFID tag associated with the tray, the identification data of the RFID tag associated with each slide of the tray and the first information of each slide, namely the above-mentioned five alphanumeric strings.

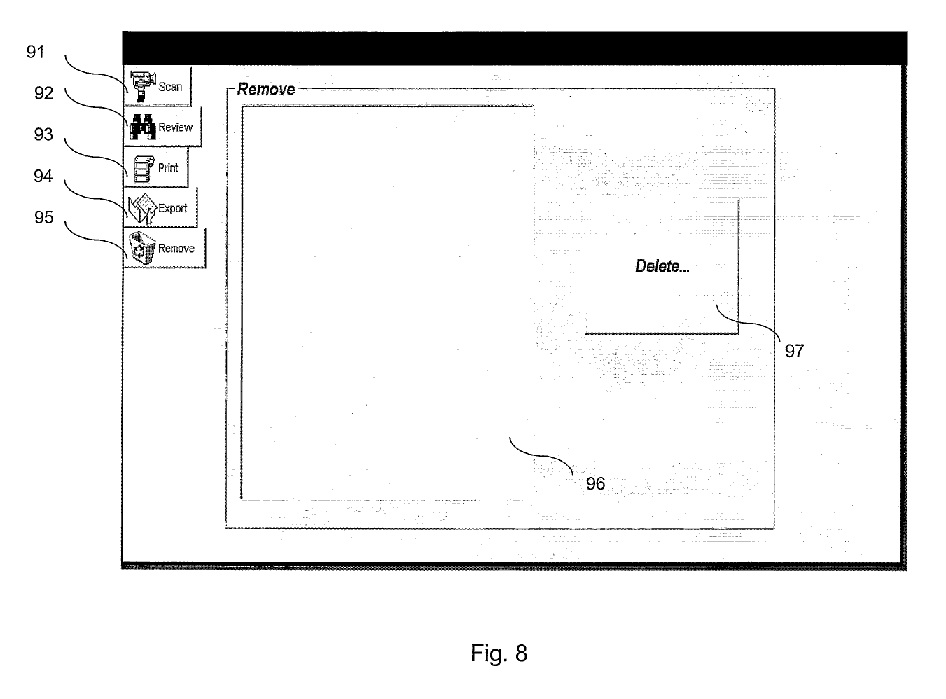

When the user has selected the remove icon 85 in FIG. 7a, the interface of FIG. 8 is displayed. It includes a list box 96 which is populated by all the tray names saved in the database 17. The list box is configured for single or multiple selections of trays. If the “delete” button 97 is pressed, the system removes the data associated with the selected trays from the database 17. The list box 96 is refreshed accordingly. Preferably, a confirmation box is displayed when the “delete” button 97 is pressed by the user. Also, in case no tray selection is made in the list box 96 and the user presses the “delete” button 97, a message box prompting the user to select one or more trays is displayed. A list of deleted trays with a user name may be made available to the user.

A box containing several trays of slides belonging to a single study may also be associated with an RFID tag label. Such an RFID tag label may be printed on a RFID reader/writer printer. A creation date in the form DDMMYYHHMMSS and a study number may be written in the memory of the tag and eventually printed on the tag label.

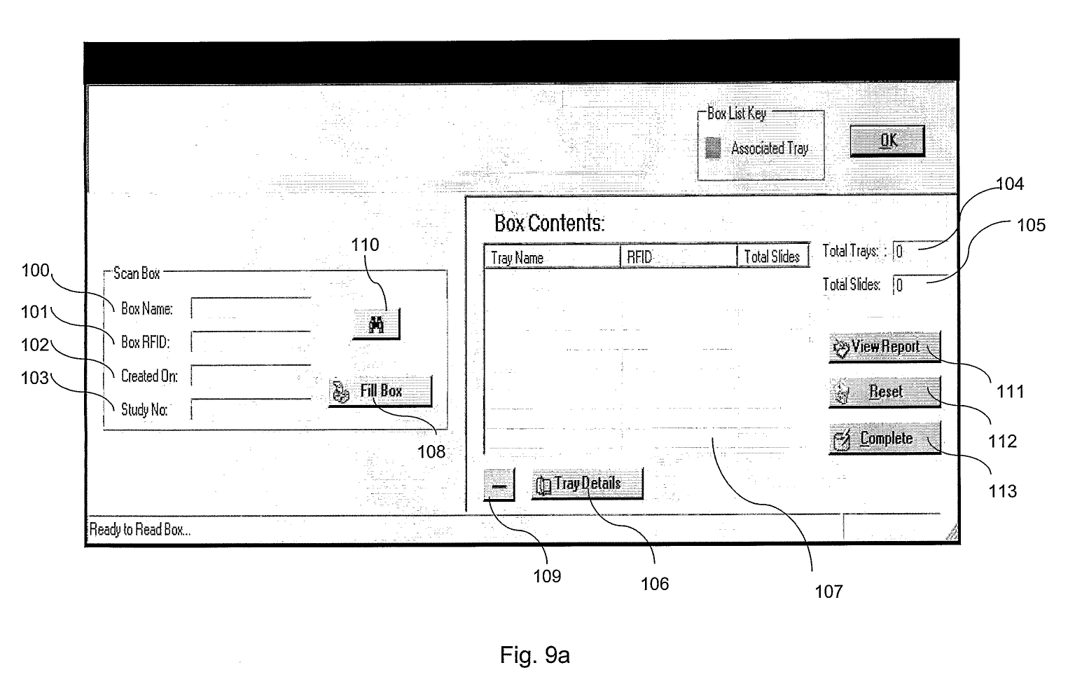

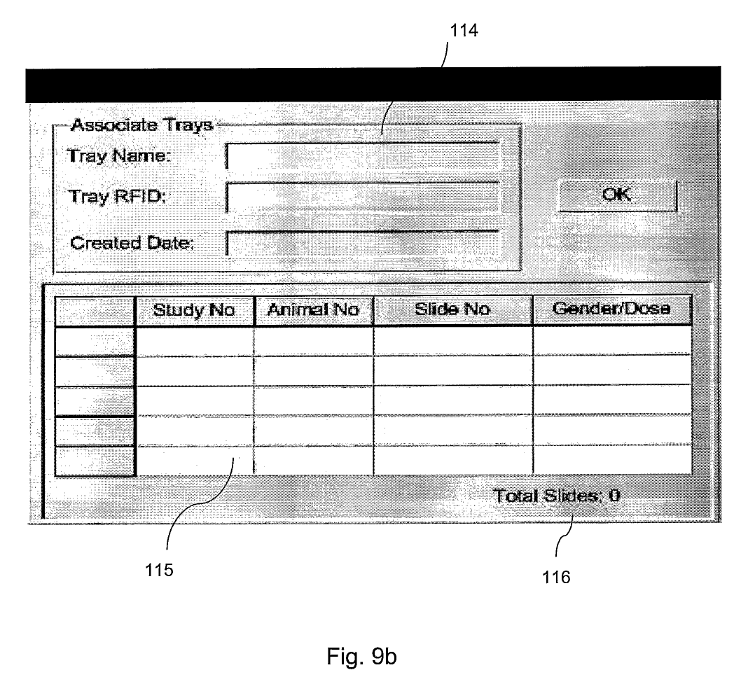

FIGS. 9a to 14 show several interfaces of the computer software which is associated with the system of the present invention. The figures will illustrate several advantages of associating RFID tags with study boxes, trays and slides using the method according to the invention as described in relation to FIGS. 1 to 8.

Using the interface of FIG. 9a which is displayed on the terminal 15, a user or administrator can add one or more trays of slides to a study box or alternatively remove one or more trays of slides from a study box. In order to do so, the user enables the scanning of the box by pressing button 110. The scanning is conducted using for example a handheld RFID reading/writing device or a RFID reading/writing platform on which the box is loaded. The RFID reading/writing device (not represented) is able to distinguish between tags using for instance the anti-collision and transmission protocols described in the international standard ISO 15693-3. The RFID reading/writing device is linked to the central unit 14. Several of these RFID reading/writing devices may be located in different sites and each may be associated with a user terminal which is linked to the central unit and its associated databases. The “box name” 100, the “box RFID” tag identification data 101, the “study number” 103 and the date of creation of the RFID tag 102 are populated accordingly. The user then presses the “fill box” button 108. The system prompts the user to scan each tray to be added, preferably one at a time, using a handheld RFID reading/writing device or a RFID reading/writing platform on which the tray is loaded. After each tray has been scanned, the “box contents” list 107 is populated with each tray name, the corresponding RFID tag identification data and the number of slides per tray. The total number of trays 104 and the total number of slides 105 are updated as scanning progresses. The system should display an error message when no box and/or no tray is located by the reading/writing device, when more than one box and/or tray is located or when one or more slides on the tray do not belong to that particular study. Using this interface, the user may add at a later stage other trays to the study by associating them to the corresponding box. In a similar manner, when scanning of the RFID tag label affixed to the box is terminated, the trays already associated with that box are listed” in the “box contents” list 107 and may be highlighted using for example a colour code. If the user scans a tray he wishes to add to the box and which is already in the “box contents” list 107, an error message is displayed. It is important that each tray added to the “box contents” list 107 is not highlighted in order to distinguish a newly added tray from a tray already associated tray with the box.

The interface of FIG. 9a also provides the user with the ability to select a tray in the “box contents” list 107 and to remove the tray and its associated slides from the box by using the erase button 109. The total number of trays 104 and the total number of slides 105 are updated accordingly. The user has the possibility to reset an operation by selecting the “reset” button 112. Extra details regarding a particular tray is enabled by first selecting a tray in the “box contents” list 107 and then clicking on the “tray details” button 106.

Consequently, the dialog box of FIG. 9b is displayed to the user. A box 114 is populated with the “tray name”, the “tray RFID” identification data and the date of creation of the RFID tag. A box 115 is populated with the first information of the associated slides, namely the study number, the animal number, the slide number, the gender/dose and the stain type (not represented). Counting of the slides contained in that particular tray is simplified, as the “total slides” 116 are automatically indicated.

Referring back to FIG. 9a, once the user has added or removed one or more trays to a box corresponding to a study, the user can finally complete the association of the box and trays by pressing the button “complete” 113. The RFID reading/writing device may write the added tray data in the memory of the RFID tag label affixed to the box. The same data is also stored in the archive database 18. A message asking the user to confirm his action is eventually displayed for extra security. Similarly, a message confirming the updating of the archive database 18 is displayed. The user is offered the possibility to print a report of the update by clicking on the “view report” button 111.

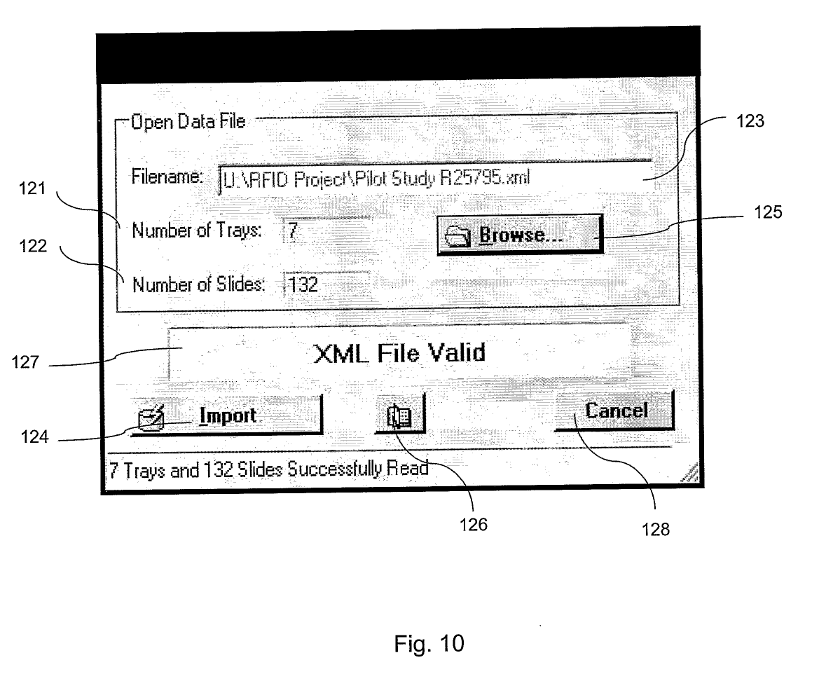

A user or an administrator has the ability to import data relating to a newly created tray or a newly created slide into the archive database 18, as shown on the interface of FIG. 10. This data is preferably stored as an XML file and imported in the same format. The user browses among the XML files of the database 17 using the “browse” button 125. A filename 123 is selected by the user. The system is able to recognize whether the file contains valid tray and slide information data that can be stored by the archive database 18. If the data is invalid, a message is displayed in box 127 informing the user that the file is not in the correct format. If the data is valid, the system displays a message in box 127 informing the user that the file has been successfully read. The system also displays the number of tray and slides included in the file, respectively in boxes 121 and 122.

If the XML file is successfully read, the user can then confirm the import of the selected XML file by pressing button 124 and start an update of the archive database 18. If the import is successful, a message box confirming the transaction success is displayed. Alternatively, a message box informing the user of the failure of the import is displayed. Once the XML file import is finished, the user can print an ‘XML Import Report’ by pressing button 126.

The system can recognize whether the file being imported in the archive database contains replacement slide data. The input of replacement data is useful when a user wishes to replace a broken slide for example. As multiple identical slides are not allowed within the archive database 18, if the system recognizes a slide within the imported file containing identical study number, animal number, stain and slide number data to that of a slide held in the archive database 18, the user is prompted to either replace the slide held within the archive database with the new record in the XML data file or ignore the replacement record in the XML data file and carry on processing the transaction.

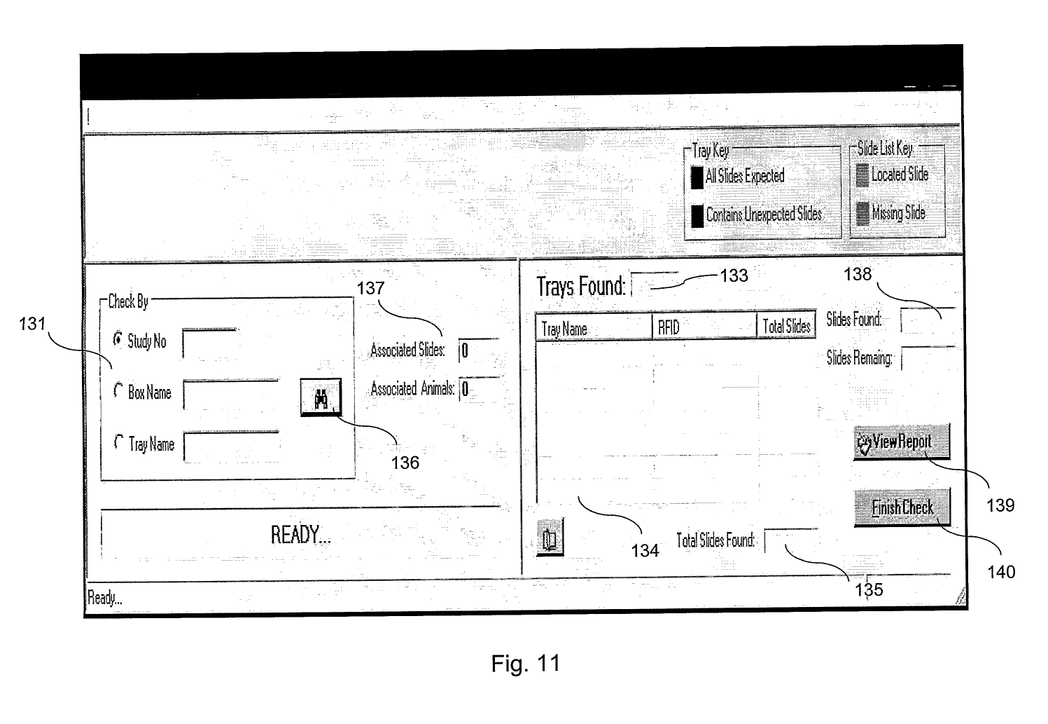

Using the interface of FIG. 11, the user has the ability to check whether a specified study or tray includes all the slides that are supposed to be associated with that study or tray. The check is done by scanning a box or a tray using any RFID reading device and by comparing the scanned data with the data retrieved from the archive database 18. Accordingly, a user first selects a “study number”, a “box name” or a “tray name” 131. Subsequently the system retrieves from the archive database the corresponding total number of slides and animals 137 of the associated study, box or tray. The system then prompts the user to scan in each tray of a study box at a time or to scan a single tray. The list of the trays and slides 134 is filled with the tray name, tray RFID tag identification data and the total number of slides on each tray. After each tray is scanned, the interface displays what has been scanned, i.e. the number of “trays found” 133, the total number of “slides found” during scanning and the total number of slides that remain to be found 138. The system compares the scanned data with the data retrieved from the archive database and highlights the trays of the list 134 which are complete. The trays which contain unexpected or missing slides may be highlighted using for example a colour code. The system enables the user to print out a check report using the “view report” button 139. The system allows the user to reset a check midway through using the “finish check” button 140. The system then clears its interface ready for the user to perform a new scan.

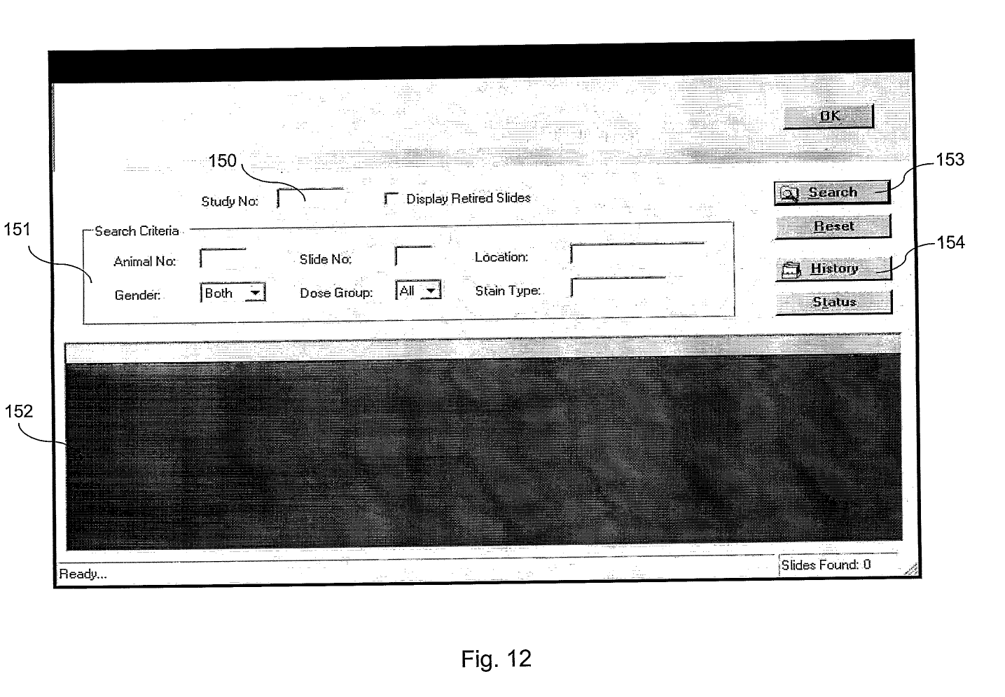

Using the interface of FIG. 12, the system allows the user to search in the archive database for and display a breakdown of all the slides associated to a specific study that meet one or more search criteria. For a particular study whose number 150 is entered manually, a corresponding list of slides is produced. The user is able to narrow his search for one or more slides by selecting one or more criteria 151 such as an animal number, a slide number, a gender, a dose group, a stain type, a location. By clicking on the “search” button 153, the user views the search results in window 152 with the selected slide data. By clicking on the “history” button 154, the user can review the history of one or more selected slides. The window 152 or a different window is populated with the history of one or more slides detailing, preferably in chronological order, the current and past locations, status, amendment data and information underlining that the slide has been replaced because of breakage for instance.

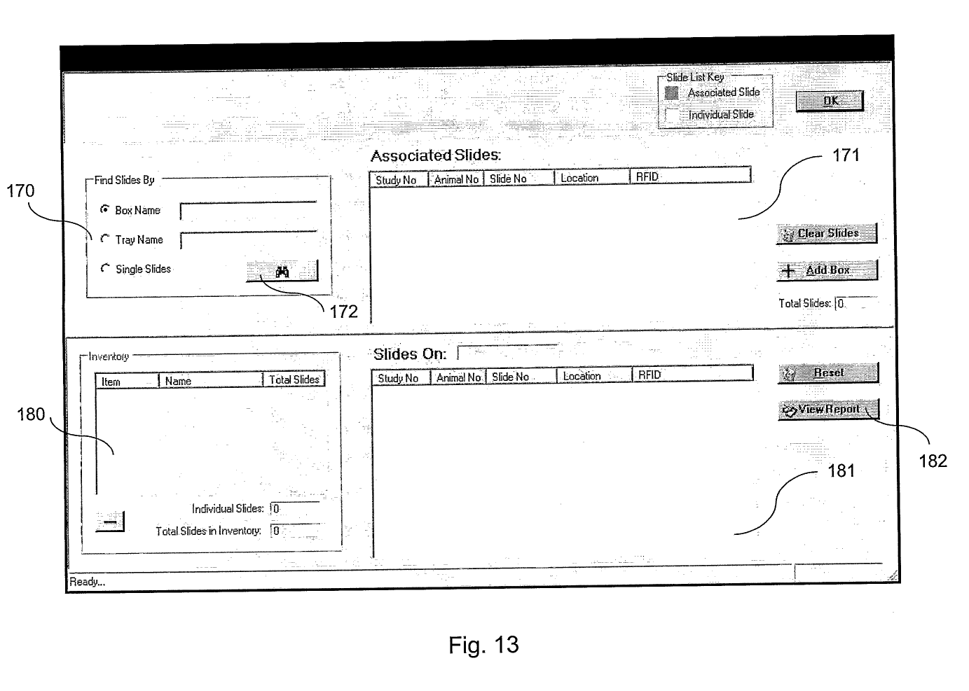

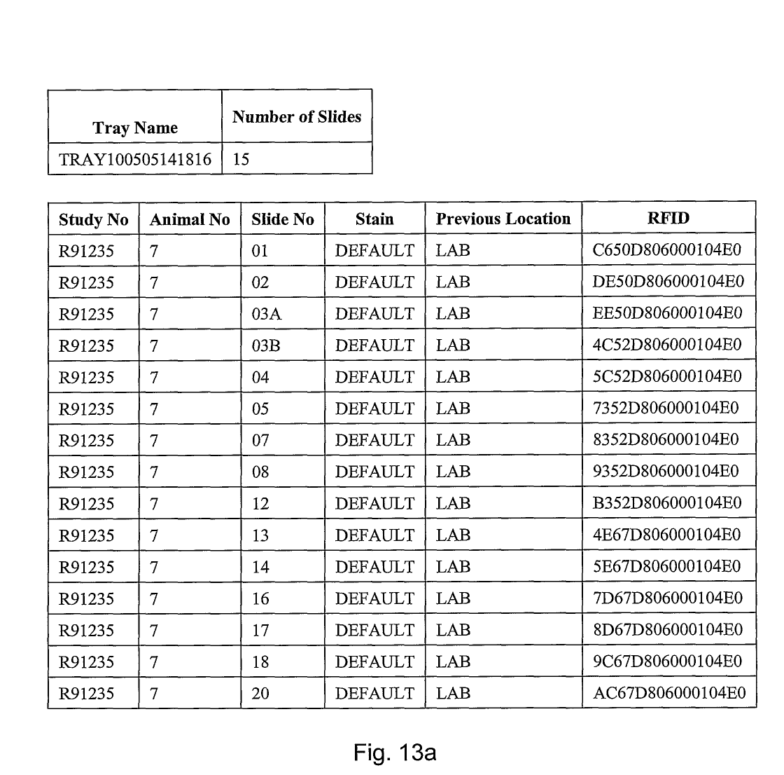

Using the interface of FIG. 13, the system allows the user to record the movement of one or more boxes, trays or slides between different locations, such as between laboratories, sites or buildings. First, the user scans the boxes, trays and/or slide(s) by first pressing icon 172 and by scanning the corresponding RFID tag labels using a RFID reader. The details of the slides are displayed in the list 171. When scanning is terminated, the user adds them to the movement list 181 and can repeat the process for another slide, tray or box. The details of the one or several associated slides can be viewed in the lists 171 and 181, particularly the actual location of each slide. The system allows the user to check-in or check-out the one or more boxes, trays or slides. If the movement is a check-out, the user should be able to select an intended location. On completion of the movement, the system allows the user to print out a report of the movement using the “view report” button 182. FIG. 13a shows an example of a movement report, which is preferably a XML file, where a tray including fifteen slides has been moved from a laboratory to an archive.

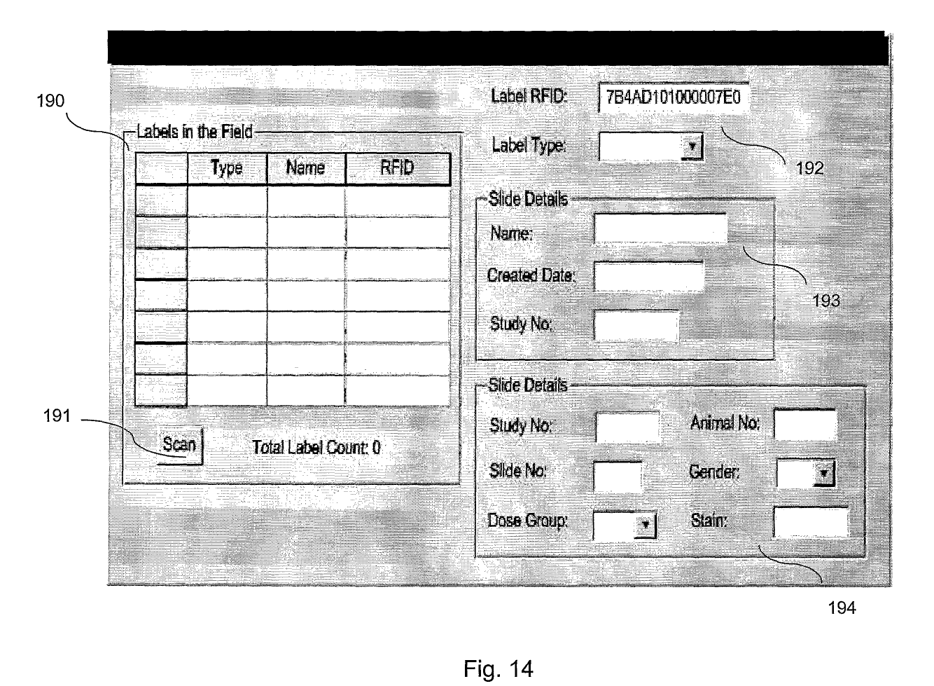

At any time the user can also view the data stored in a RFID tag affixed to a slide as shown on FIG. 14. Using the “scan” button 191, the one or more RFID tag labels within an RFID reader field are scanned. The user can view data 190 associated with the one or more scanned RFID tags and a count of these tags. For a particular RFID tag selected in box 190, the user can view the RFID tag details 192, the corresponding slide details 193 and first information 194.

There are several advantages of replacing the existing first information medium on the slides by RFID tags or adding RFID tags to the slides, as well as adding RFID tags to trays and boxes, as has been described in relation to the invention. During further processing of a study, tracking and accounting of slides and/or trays is made easier, faster and more accurate. It also requires minimal human intervention. The invention replaces the need to manually handle, identify and count microscope slides, but also simplifies the input processes of data in a database.

By use of the method and apparatus according to the invention, the details of each slide are input into a local database via an automated process and/or manual process and are further archived. The computer software associated with the present invention has the ability to generate a list of slides contained within a study box and provides a user with the ability to search for single and/or multiple slides from box to tray level. The computer software can provide a user with a count of the actual number of slides scanned and provide details of any expected slides which are not present. A user has the ability to change the status of a slide within the system, for instance when a slide is broken. It can add a replacement slide to the database and mark the relation between the new slide and the broken slide. Any change of the original data entered, such as the slide movement history and reason for change, can also be entered into the database. A facility for searching a study using a filter is provided. Also provided is the ability to create reports on slide location or on contents of a study box and to create a list of slides for exporting to another site or to another local site location.

In relation to the present invention, additional information may be added locally to a slide RFID tag by incorporating a tag reader/writer module in a microscope, so that while a pathologist is setting up to view a slide, his terminal processes the information read from the slide and opens an appropriate application where he can enter his observations and/or diagnosis. Similarly, a tag reader/writer module may be attached to a microtome which is used to cut thin sections of tissue in order to obtain tissue samples which are then deposited on slides. This would ensure that the slides have the correct details of their associated tissue sample.

The above embodiments are to be understood as illustrative examples of the invention. Further embodiments of the invention are envisaged. For example, the invention may be applied to microscope slides having various sizes and various information mediums. The samples may be, for instance, biological samples but alternatively may be any other form of samples which may be suited or required for microscope examination. The samples may be in any convenient form for examination, for example microtome sections. The trays may accommodate more or less than twenty four slides, and be loaded on and unloaded from the robotic platform automatically. Also, several trays may be scanned in a single scan cycle. RFID tags may be active tags and operate at different frequencies. The invention may also be applied to other biological sample carriers such as tissue cassettes, to bags containing excised tissue samples, to boxes containing plastic bags of tissue samples, to sample bottles containing a tissue sample before the tissue is embedded into a polymer block or to a polymer block holder used in histology, cytology and biomedical research laboratories. Finally, the data may be stored in the database and archive database in files other than XML files.

It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

What is claimed is:

1. A method of marking a biological sample carrier by transferring information from a first information medium forming part of the sample carrier to a second information medium, said first information medium being optically readable and said second information medium being electronically readable, said method comprising the steps of:
(a) determining first information from said first information medium;
(b) associating said first information with said second information medium;
(c) storing said sample carrier with said second information medium attached to said sample carrier.

2. A method according to claim 1, wherein step (b) comprises writing said first information into said second information medium.

3. A method according to claim 1, wherein step (b) comprises the steps of:
(d) storing said first information in a database;
(e) reading identification data from said second information medium;
(f) storing in said database said identification data in association with said first information.

4. A method of marking one or more sample carriers according to claim 1, wherein said one or more sample carriers are arranged on a tray, said method further comprising the steps of:
(g) associating said first information of said one or more sample carriers on said tray with a third information medium, said third information medium being electronically readable;
(h) storing said tray with said third information medium attached to said tray.

5. A method according to claim 4, said method further comprising the steps of:
reading identification data from said third information medium;
(j) storing said identification data of said third information medium in said database in association with said first information and said identification data of said second information medium.

6. A method according to claim 1, further comprising the step of:
(k) printing at least part of said first information which is stored in said database onto said second information medium.

7. A method according to claim 6, wherein steps (b), and (k) are conducted by at least a printing device having data reading and writing means.

8. A method according to claim 1, wherein said second and/or third information medium is a radio frequency identification tag.

9. A method according to claim 7, said printing device having radio frequency identification tag reading and writing means.

10. A method according to claim 1, step (a) being conducted by capturing an image of said first information medium and determining said first information from said captured image.

11. A method according to claim 1, wherein in step (b), identification data is also associated with said second information medium.

12. A method according to claim 4, wherein in step (g), identification data is also written into said third information medium.

13. A method according to claim 1, wherein in step (c), said second information medium is affixed on top of said first information medium.

14. An apparatus for marking a biological sample carrier by transferring information from a first information medium forming part of the sample carrier with a second information medium, said first information medium being optically readable and said second information medium being electronically readable and affixable or affixed to the sample carrier, said apparatus comprising:
(a) a reader for reading first information from said first information medium;
(b) a writer for writing said first information in said second information medium.

15. An apparatus according to claim 14, said apparatus further comprising:
(c) a reader for reading identification data from said second information medium;
(d) a database for storing said first information and said identification data of said second information medium in correspondence with said first information.

16. An apparatus according to claim 14, said apparatus having a tray holder for holding a tray comprising one or more biological sample carriers, said apparatus further comprising:
(e) a writer for writing said first information of the one or more sample carriers of said tray in a third information medium, said third information medium being electronically readable and affixable or affixed to the tray.

17. An apparatus according to claim 16, said apparatus further comprising:
(f) a reader for reading identification data from said third information medium, the database being adapted for storing said identification data in correspondence with said first information and said identification data of said second information medium.

18. An apparatus according to claim 17, said apparatus further comprising:
(g) a printer for printing said first information and/or corresponding identification data of said information medium stored in said database on said second information medium.

19. An apparatus according to claim 18, said reader and/or writer having means for operating on a radio frequency identification tag.

20. An apparatus according to claim 14, wherein the first reader includes computing means to capture an image of said first information medium and to determine said first information from said captured image.

21. An apparatus according to claim 14, further including a terminal.

22. (canceled)

23. A biological sample carrier comprising a first information medium and a second information medium, the first information medium being of a different kind than the second information medium, and having a part for receiving a sample.

24. A biological sample carrier according to claim 23, said first information medium being optically readable and said second information medium being electronically readable and affixable or affixed to the sample carrier.

25. A biological sample carrier according to claim 23, wherein said second information medium is a radio frequency identification tag.

26. A biological sample carrier according to claim 23, said sample carrier comprising one information locator means which can be a slot or a marker.

27. A container containing one or more biological sample carriers, said container and said one or more biological sample carriers comprising radio frequency identification tags.

28. A study box containing one or more containers, said box and said one or more containers comprising radio frequency identification tags.

29. A method according to claim 4, wherein said second and/or third information medium are radio frequency identification tags.
